(19) United States
(12) Patent Application Publication
(10) Pub. No.: US 2005/0046134 A1
(43) Pub. Date: Mar. 3, 2005

(54) Multi-terrain child carriage

(76) Inventors: Vincente H. Gracias, Cherry Hill, NJ (US); Felipe Gracias, Palos Heights, IL (US); Antonio Gracias, Jackson, WY (US); Maria L. Gracias, Chicago, IL (US)

Correspondence Address: Robert J. Schneider;Chapman and Cutler LLP, 16th Floor, 111 West Monroe Street, Chicago, IL, 60603-4080, US

(21) Appl. No.: 10/650,636

(22) Filed: Aug. 28, 2003

(51) Int. Cl. B62B 7/00

(52) U.S. Cl. 280/47.38

(57) ABSTRACT

A multi-terrain child carriage having a body portion that has a bottom surface adapted to sliding over snow or ice. The body is provided with at least one wheel, each such wheel rotatably mounted on an axle so as to be rotatably connected to the body. The wheels are positioned in a manner which allows a lowermost portion of the wheels to extend slightly below the bottom surface of the body, so that the bottom periphery of the one or more wheels may contact the surface over which the carriage is moving, but so that enough of the wheel extends downward from the bottom surface of the body so as to allow the wheels to bear the weight of the carriage when the carriage is moved from a snowy surface to a solid, snow-free surface, such as a dry or clear paved surface, without the need for adjustment or attachments. The carriage also comprises a child seat or bed affixed to the body, a means for pushing or pulling the carriage, and means for holding ski equipment, such as skis and ski poles, and parcels.

### BACKGROUND OF THE INVENTION

The present invention is an improvement on conventional child carriages and sleds providing new features and advantages particular to skiing. Prior designs for vehicles for transporting children do not accommodate the special needs of skiers. Conventional wheeled strollers cannot be pushed through snow in a convenient and easily navigable fashion. Prior designs for children's sleds typically have no features enabling them to be pushed and pulled across non-snow and non-ice surfaces, such as paved surfaces, without requirement for conversion, adjustment, or attachment of additional parts, and have no features for convenient transport of skis, ski poles, and other objects. In contrast to previous designs, our invention allows a skier to transport a child, skis, poles, and other parcels or accessories across both paved and snowy or icy surfaces without the need to stop for adjustment or conversion of the child's carriage. It is an object of this invention to provide a unitary, convenient mode of transport of at least one child together with ski equipment and parcels across multiple types of terrain without need for adjustment or conversion of the carriage.

### SUMMARY OF THE INVENTION

According to the present invention, there is provided a multi-terrain child carriage having a body portion that has a bottom surface adapted to sliding over snow or ice. The body is provided with at least one wheel, each such wheel rotatably mounted on an axle so as to be rotatably connected to the body. The wheels are positioned in a manner which allows a lowermost portion of the wheels to extend slightly below the bottom surface of the body, so that the bottom periphery of the wheel(s) may contact the surface over which the carriage is moving, but so that enough of the wheel extends downward from the bottom surface of the body so as to allow the wheels to bear the weight of the carriage when the carriage is moved from a snowy surface to a solid, snow-free surface, such as a dry or clear paved surface, without the need for adjustment or attachments. The carriage also comprises a child seat or bed affixed to the body, a means for pushing or pulling the carriage, and means for holding ski equipment, such as skis and ski poles, and parcels.

### BRIEF DESCRIPTION OF THE DRAWINGS

FIG. 1 is a perspective view of the first embodiment of the present invention.

FIG. 2 is a perspective view of the second embodiment of the present invention, showing the child carrier portion disengaged from the carriage.

FIG. 3 is a front elevation view of the second embodiment of the present invention, showing the child carrier portion disengaged from the carriage.

FIG. 4 is a side elevation view of the second embodiment of the present invention, showing the child carrier portion installed in the carriage.

### DETAILED DESCRIPTION OF THE INVENTION

According to the present invention, there is provided a multi-terrain child carriage, generally designated 10, having a body, generally designated 12, which has a bottom surface 14 adapted for sliding contact over snow or ice. The body 12, including its bottom surface 14, is advantageously formed of a rigid thermoplastic material. The bottom surface 14 is advantageously shaped to have at least one guiding edge 16, as best seen in FIG. 3. The guiding edges 16 are molded, downwardly-protruding ribs positioned on the bottom surface 14 of the body 12, extending lengthwise from the front end 18 to the rear end 20 of the body 12. Such guiding edges 16 serve to promote directional control of the carriage 10 as it moves over snowy surfaces. The carriage 10 preferably includes a plurality of such guiding edges 16 for stability.

The carriage 10 also has a plurality of wheels 22, each rotatably mounted on an axle 24 affixed to the body 12. The wheels 22 rotate upon their axles 24 as the carriage 10 is moved over surfaces. It is advantageous to provide at least three or four wheels 22, to promote stability. The wheels 22 are affixed to the body 12 in a manner which allows a bottom periphery 52 of said wheels 22 to extend slightly below the bottom surface 14 of the body 12. Ideally, the wheels 22 are positioned so that their bottom-most peripheries 26 are in contact with the surface over which the carriage 10 is moving, in a position allowing a sufficient portion of the wheels 22 to extend downwardly from the bottom surface 14 of the body 12, so as to allow the wheels 22 to bear the weight of the carriage 10 and its contents when the carriage 10 is on a solid clear surface, such as a dry paved surface.

Ideally, the wheels 22 are positioned with their downward projection small enough that the wheels 22 do not interfere with a sled-like sliding movement of the bottom surface 14 of the body 12 over snow or uneven ice surfaces. The downward projection of the wheels 22 can be adapted to be upwardly or downwardly adjustable, if desired, in order to promote ease of navigation of the carriage 10 over a variety of surface conditions such as different depths of snow or slush.

It is advantageous, if desired, to affix one or more of the axles 24 to the body 12 in a manner that allows the direction of the one or more wheels 22 mounted on such axle(s) to differ from the direction of movement of the carriage 10, to allow for easier steering of the carriage. This may be accomplished, for example, by providing a means 28 for rotation of one or more of the axles, as best seen in FIG. 3. This axle rotation means 28 may be designed as a caster-type mechanism.

The carriage 10 also may provide, if desired, a means 30 for braking the wheels 22, to secure the carriage 10 in a stopped position. The braking means 30 may be designed, for example, as a pivoting lever mounted so as to provide friction with one or more of the wheels 22, best seen in FIG. 4.

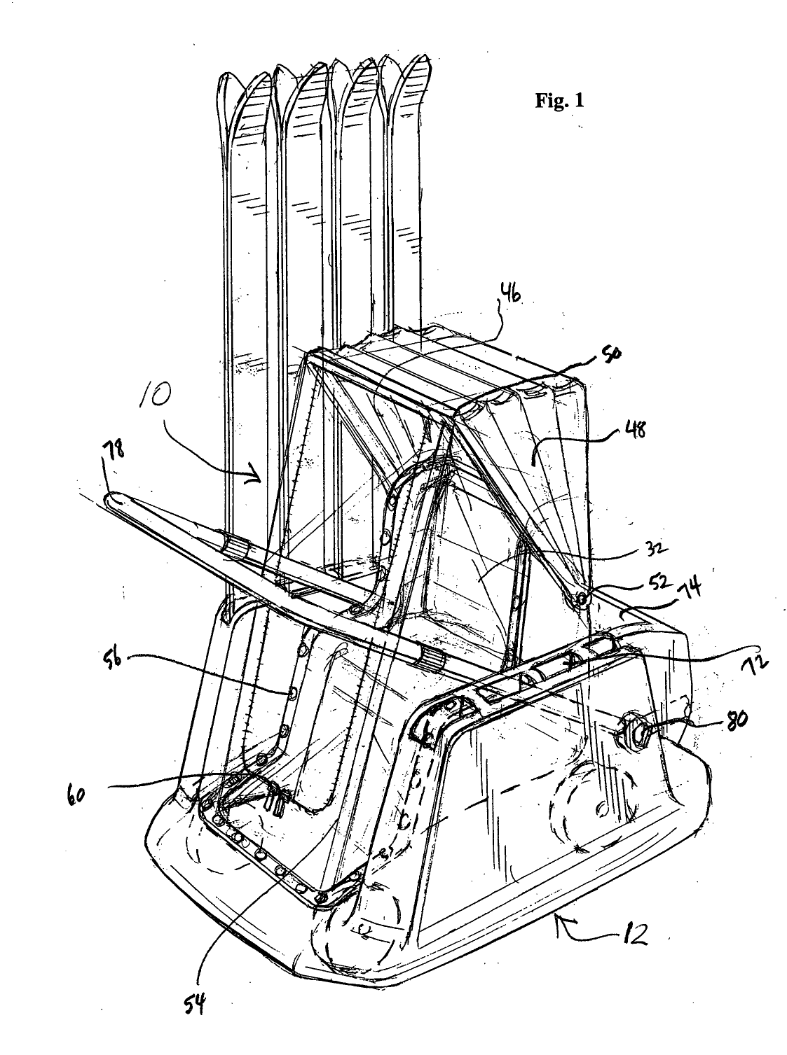

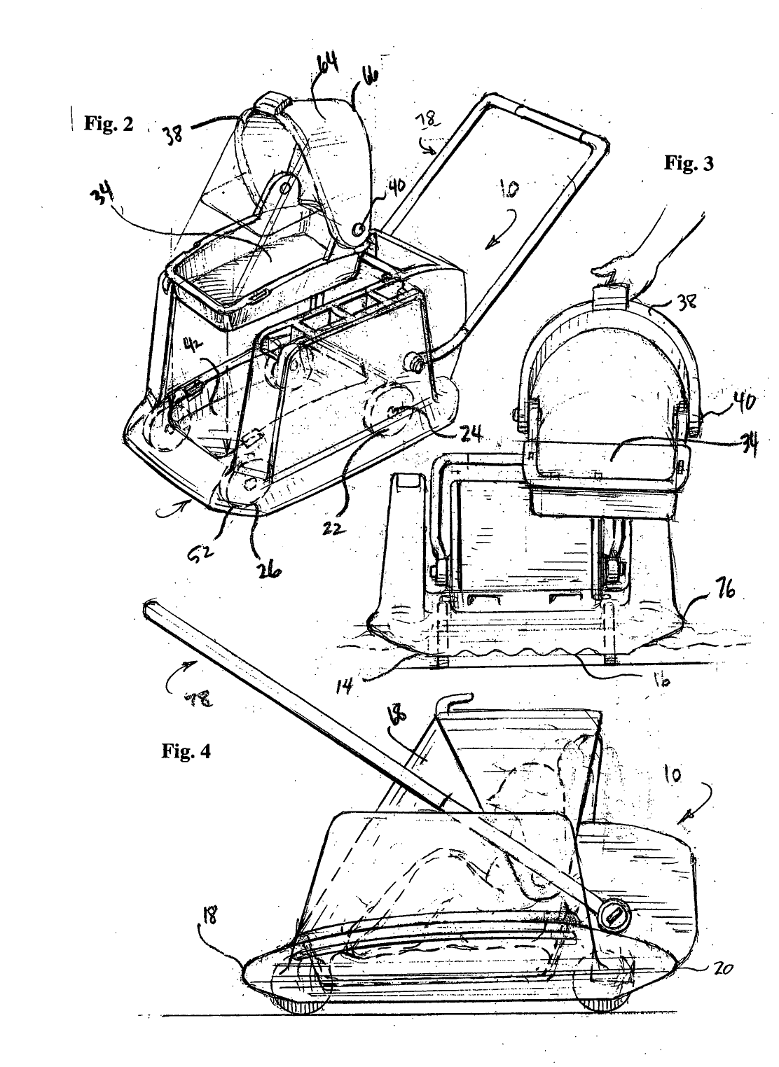

The carriage 10 also comprises a means for carrying one or more infants or children (herein, “child” or “children” also includes “infant” or “infants”). Many alternative designs for such means are available. Such means for carrying a child may be a child seat portion generally designated 32, of the body 12 as shown in the first embodiment in FIG. 1, or may be a removable child carrier, generally designated 34 as shown in the second embodiment in FIGS. 2, 3 and 4. The child seat portion 32 or child carrier 34 is affixed to the body 12, extending upward from the top surface 36 of the body 12. Any means for carrying one or more children can serve as this child seat portion 32 or child carrier 34. The seat portion 32 or carrier 34 can be shaped to accommodate one or more children in a sitting position or a lying-down position. The seat portion or carrier can be adapted, if desired, to be adjustable in order to provide the child or children with a plurality of sitting positions or lying-down positions.

In the first embodiment of the invention, seen in FIG. 1, the child seat portion 32 is permanently affixed to or is formed integrally with the body 12.

In a second embodiment of the invention, seen in FIGS. 2, 3, and 4, the means for carrying one or more children may be designed as a removable child carrier 34 to facilitate the removal of a child from the carriage 10, by lifting out the child carrier 34. The removable child carrier 34 has a carrier handle 38 allowing the lifting of the child carrier 34 for removal from the body 12 of the carriage 10. The carrier handle 38 may be made to be pivotally mounted to the child carrier 34 via a carrier handle fastener 40, which fastens the carrier handle 38 to the child carrier 34, and may be designed to pivot. In this second embodiment, the body 12 of the carriage 10 has a means 42 for holding the child carrier 34, in its position on the body 12.

In the second embodiment with the removable child carrier 34, the means 42 for holding the child carrier 34 may be designed as a receptacle 42 for securing or containing the removable child carrier 34. The means 42 for holding the child carrier may be shaped to accept different models of child carriers, which child carriers may be provided separately from the carriage of this invention, perhaps manufactured by other makers.

It is, of course, advantageous to provide a means 44 to secure the child in the seat portion 32 or carrier 34, such as a seatbelt, as shown in both embodiments in FIGS. 1 and 2.

It also is advantageous to provide an additional feature of a protective cover, generally designated 46 in FIGS. 1-4, upon the body 12 of the carriage 10. The cover 46 advantageously is shaped to form an area around the child seat portion 32 or child carrier 34, that is protected by the cover 46 from snow, wind, cold, mud, or other adverse conditions. The cover 46 may be integral or removable with respect to the body 12. The cover 46 may advantageously be designed to thermally insulate the area inside the cover.

As shown in FIG. 1, the cover 46 is designed for used with the first embodiment of the invention. The cover 46 includes a hood portion 48. The hood portion 48 may be designed to be retractable toward the rear end 20 of the body 12, to allow access to the child, or to allow sun to reach the child in the child seat portion 32. The hood portion 48 may be formed of a flexible, water-resistant fabric or plastic material adapted to be stretched over at least one support member 50, pivotally and removably attached to the body 12 by means of a pivotal hood connector 52. The hood portion 48 thereby may be alternately stretched forward for use, or folded back, according to pivotal movement of the support member(s) 50.

As further shown in FIG. 1, the cover 46 may further include a removable barrier portion 54 for protection from wind or other adverse conditions. The barrier portion 54 preferably is formed of transparent material, and includes means 56 for removably attaching the barrier portion 54 to the body 12, such means being depicted as snaps in FIG. 1. The barrier portion 54 may be removably attached to the support member 50 of the hood portion 48, by means 58 for removably attaching the barrier portion 54 to the hood portion 48, shown in FIG. 1 as snaps. The barrier portion 54 preferably includes a means 60 for accessing the child in the child seat portion 32 of the body 12, depicted in FIG. 1 as a zipper allowing opening of a section of the barrier portion 54. If the barrier portion 54 is impervious to air, the barrier portion 54 advantageously may include means 62 for ventilation, shown as a ventilation panel in FIG. 1.

As shown in FIGS. 2, 3 and 4, the cover 46 may be designed for use with the second embodiment of this invention. In the second embodiment as shown in FIGS. 2, 3, and 4, the cover 46 includes a carrier hood 64. The carrier hood 64 may be formed of a rigid or flexible fabric or plastic material, extending between the child carrier handle 38 and at least one carrier hood support member 66. The carrier hood 64 thereby may be alternately moved forward to protect the child from wind or sun, or folded back to allow access to the child, according to pivotal movement of the carrier hood support member 66 and/or the carrier handle 38, via the means 40 for pivotally fastening the carrier handle 38 (and, optionally, the one or more carrier hood support member(s) 66) to the child carrier 34. The carrier hood 64 also may be designed to be removable from the child carrier 34, in accordance with the wishes of the person using the carriage 10, by designing the carrier handle fastening means 40 to allow removal and reattachment of the carrier hood 64.

As further shown in FIG. 4, the cover 46 as adapted for use with the second embodiment of the invention may further include a removable barrier portion 68 for protection from wind or other adverse conditions. The barrier portion 68 preferably is formed of transparent material, and may include means 70 for ventilation within the cover 46, shown as a ventilation panel in FIG. 4.

The carriage 10 also comprises a means for carrying skis and/or ski poles, generally designated 72. The ski and/or ski pole carrying means 72 may advantageously be mounted to the sides 76 of the body 12 or the rear end 20 of the body 12, extending upwardly from the body 12 of the carriage 10. The carrying means 72 advantageously may be formed as one or more deep, partitioned boxes or wells 72 integrally formed in the body 12 of the carriage 10. The well 72 is deep enough to provide stable support for skis, and ski poles when the rear portions of the skis are inserted vertically downwardly into the well 72. The carrying means 72 may be positioned on one or both sides 76 of the body 12, so as to hold the skis or ski poles upright, but away from the forward line of sight of the person navigating the carriage 10, as depicted in FIGS. 1-4. Many alternate designs can be used to provide other systems for carrying the skis or ski poles, including clamps, hooks and/or straps.

The carriage 10 also may provide a means 74 for carrying or holding parcels affixed to the body 12 of the carriage 10. Such parcel carrying means 74 may be designed to extend upwardly from the body 12, or be formed integrally in the body 12 as receptacles or wells. The parcel carrying means 74, and are utilizable either with or without the cover 46 described above. The parcel carrying means 74 may be provided on or near the front end 18, rear end 20, or one or both sides 76 of the body 12.

The carriage 10 also has a handle means for pushing or pulling the carriage 10, generally designated 78. The handle 78 is pivotally connected to the rear end 20 of the body 12, as shown in FIGS. 1, 2 and 4, by a carriage handle connector 80. The carriage handle connector 80 is designed to allow pivotal attachment of the carriage handle 78 to the body 12, and if desired, may be designed to allow removable attachment of the carriage handle 78 to the body 12. The pivoting of the carriage handle 78 allows the carriage handle 78 to extend upwardly from the body 12, and to pivot upon the carriage handle connector 80 to facilitate pushing or pulling, making movement of the carriage 10 reversible. The carriage handle 78 is sized and shaped to accommodate pushing by a person standing behind the carriage 10, or pulling by a person standing in front of the carriage 10. Normally, the carriage handle 78 could be a simple handle similar to those in prior art strollers, to be pushed or pulled by the hands of the person navigating the carriage 10. Optionally, the means 78 for pushing or pulling the carriage is adapted to fold, telescope, bend, or be entirely removed, in order to make the carriage 10 more compact for storage or transportation.

Many variations of the previously described multi-terrain child carriage can be made without departing from the scope of this invention. The foregoing description of the preferred embodiments is intended to illustrate a specific configuration according to the general principle of this invention.

1. A multi-terrain child carriage, comprising:
a body, said body having a bottom surface, said bottom surface being adapted to slide across snow, and having at least one guiding edge positioned on the bottom surface of the body;
the body further having a child seat portion, a means for pushing or pulling said carriage pivotally mounted to the body, a means for carrying skis affixed to the body, and a means for carrying parcels affixed to the body; and
at least one wheel, each such wheel rotatably mounted onto an axle affixed to the body, each such wheel having a bottom periphery, wherein said at least one wheel is rotatably mounted so that the bottom periphery of said at least one wheel extends downwardly from the bottom surface of said body, so as to contact a solid surface over which the carriage is moving, to enable said carriage to roll upon such at least one wheel over the solid surface.

2. The carriage according to claim 1, further comprising means for rotation of at least of one of said axles, rotatably mounted to the body and rotatably mounted to the at least one axle.

3. The carriage according to claim 1, further comprising means for braking the carriage affixed to said body.

4. The carriage according to claim 1, further comprising a means for securing a child in said child seat portion affixed to the body.

5. The carriage according to claim 1, further comprising a cover removably affixed to the body.

6. A multi-terrain child carriage, comprising:
a body, said body having a bottom surface, said bottom surface being adapted to slide across snow, and having at least one guiding edge positioned on the bottom surface of the body;
the body further having a child seat portion, a means for pushing or pulling said carriage pivotally mounted to the body, a means for carrying skis affixed to the body, and a means for carrying parcels affixed to the body;
at least one wheel, each such wheel rotatably mounted onto an axle affixed to the body, each such wheel having a bottom periphery, wherein said at least one wheel is rotatably mounted so that the bottom periphery of said at least one wheel extends downwardly from the bottom surface of said body, so as to contact a solid surface over which the carriage is moving, to enable said carriage to roll upon such at least one wheel over the solid surface;
means for rotation of at least of one of said axles, rotatably mounted to the body and rotatably mounted to the at least one axle;
means for braking the carriage, affixed to said body;
means for securing a child in said child seat portion, affixed to the body; and
a cover removably affixed to the body.

7. A multi-terrain child carriage, comprising:
a body, said body having a bottom surface and a top surface, said bottom surface being adapted to slide across snow, and having at least one guiding edge positioned on the bottom surface of the body;
the body further affixed to it a means for holding a removable child carrier, a means for pushing or pulling said carriage pivotally mounted to the body, a means for carrying skis affixed to the body, and a means for carrying parcels affixed to the body; and
at least one wheel, each such wheel rotatably mounted onto an axle affixed to the body, each such wheel having a bottom periphery, wherein said at least one wheel is rotatably mounted so that the bottom periphery of said at least one wheel extends downwardly from the bottom surface of said body, so as to contact a solid surface over which the carriage is moving, to enable said carriage to roll upon such at least one wheel over the solid surface.

8. The carriage according to claim 7, further comprising means for rotation of at least of one of said axles, rotatably mounted to the body and rotatably mounted to the at least one axle.

9. The carriage according to claim 7, further comprising means for braking the carriage affixed to said body.

10. The carriage according to claim 7, further comprising a child carrier removably attached to said means for holding a removable child carrier.

11. The carriage according to claim 7, further comprising a cover removably affixed to the body.

12. A multi-terrain child carriage, comprising:
a body, said body having a bottom surface and a top surface, said bottom surface being adapted to slide across snow, and having at least one guiding edge positioned on the bottom surface of the body;
the body further affixed to it a means for holding a removable child carrier, a means for pushing or pulling said carriage pivotally mounted to the body, a means for carrying skis affixed to the body, and a means for carrying parcels affixed to the body;
at least one wheel, each such wheel rotatably mounted onto an axle affixed to the body, each such wheel having a bottom periphery, wherein said at least one wheel is rotatably mounted so that the bottom periphery of said at least one wheel extends downwardly from the bottom surface of said body, so as to contact a solid surface over which the carriage is moving, to enable said carriage to roll upon such at least one wheel over the solid surface;
means for rotation of at least of one of said axles, rotatably mounted to the body and rotatably mounted to the at least one axle;
means for braking the carriage affixed to said body;
a child carrier removably attached to said means for holding a removable child carrier; and
a cover removably affixed to the body.
